(19) United States
(12) Patent Application Publication
(10) Pub. No.: US 2014/0147678 A1
(43) Pub. Date: May 29, 2014

(54) Solvent Resistant Nylon Films

(71) Applicant: Christine Rose Melbye, Neenah, WI (US)

(72) Inventor: Christine Rose Melbye, Neenah, WI (US)

(21) Appl. No.: 13/687,048

(22) Filed: Nov. 28, 2012

(51) Int. Cl. B32B 27/08

(52) U.S. Cl. CPC B32B 27/08
USPC 428/423.5; 428/475.5; 428/476.1

(57) ABSTRACT

The present invention relates to an oxygen-barrier food packaging film having a coating on an exterior nylon surface which prevents the absorption of hydrocarbon solvents and provides a surface for multiple layers of printing

### FIELD OF THE INVENTION

The present invention relates to printed oxygen-barrier nylon films and particularly to printed oxygen-barrier nylon films having a solvent-barrier coating of polyvinylidene chloride.

### BACKGROUND OF THE INVENTION

It is common practice to package articles such as food products in multilayer films or laminates to protect the packaged product from abuse and exterior contamination. The multilayer films or laminates provide convenient and durable packages for transportation and ultimate sale to the end user. It is usual to include printed indicia like decorations and text on packaging films. Printed thermoplastic films for use in food packaging applications are well known. Generally, printed images are applied to the non-food outside layer of the packaging film (i.e., the side of the film opposite the food contact side) utilizing printing techniques that are known in the art. Such printing techniques include gravure, rotary screen, or flexographic techniques. Ink systems for forming the printed image or wording on packaging films are also known in the art. Standard or conventional ink systems typically include pigments carried in a resin solubilized in a carrier solvent. Typical carrier solvents for the resins include hydrocarbon solvents, such as alcohols, acetates, aliphatic hydrocarbons, aromatic hydrocarbons, and ketones.

In gravure printing, for example, the printing surface is typically a rotating cylinder, frequently a copper cylinder, which rotates in a bath of the ink to pick up the ink in the engraved elements of the cylinder. Excess ink is removed from the roller by a blade and the roller then comes into contact with the packaging film to be printed. The image is thereby transferred to the film, which then passes into an oven where the ink solvent is vaporized so that the ink is dried and a secure print image remains on the substrate. A typical gravure ink may include from 40% to 60% by weight of solvent, based on the total weight of the ink formulation.

Spectacular visual effects can often be achieved by printing multiple layers of printing ink and/or covering larger areas of a packaging film. Such complex printing has the advantage of allowing visual depth and spatial effects to be more convincing and realistic. However, some food packaging materials, particularly oxygen-barrier films having a nylon exterior surface, absorb printing solvents into the film structure before they are vaporized. Even small amounts of ink solvent absorbed into packaging film is a particularly difficult problem to resolve since it can slowly permeate through the film and eventually contaminate packaged food. Consequently, it becomes necessary to limit the amount of printing to these packaging materials in order to minimize or eliminate the amount of absorbed solvent.

Therefore, oxygen-barrier food packaging films with a nylon exterior surface having complex printed graphics are highly desired.

### SUMMARY OF THE INVENTION

The present invention provides an oxygen-barrier food packaging film having a coating on the nylon exterior surface which prevents the absorption of hydrocarbon solvent into the film and provides a surface for printed graphics layer.

In one aspect, the present invention provides an oxygen-barrier food packaging film which is substantially free of organic solvent comprising a multilayer substrate having an exterior surface of nylon; wherein the substrate has an oxygen transmission rate of less than 0.016 cm³/mil/100 in²/24 h at 73° F. and 0% RH (or 0.24 cm³/mil/m²24 h at 23° C. and 0% RH). The packaging film comprises a primer coating on the nylon exterior surface layer of the substrate; a polyvinylidene chloride coating overlying the primer coating, and a printed graphics layer covering at least a portion of the polyvinylidene chloride coating.

In another aspect, the present invention provides an oxygen-barrier food packaging film having multiple layers of printing which is substantially free of organic solvent, and comprising a multilayer substrate having an exterior surface of nylon, wherein the substrate has an oxygen transmission rate of less than 0.016 cm³/mil/100 in²/24 h at 73° F. and 0% RH (or 0.24 cm³/mil/m²/24 h at 23° C. and 0% RH). The packaging film comprises a primer coating on the nylon exterior surface layer of the substrate; a polyvinylidene chloride coating overlying the primer coating, a printed graphics layer covering at least a portion of the polyvinylidene chloride coating, and an over lacquer or varnish covering the printed graphics layer.

### BRIEF DESCRIPTION OF THE DRAWINGS

FIG. 1 depicts a cross-sectional view of one embodiment of the present invention.

FIG. 2 depicts a cross-sectional view of another embodiment of the pr invention.

FIG. 3 depicts a cross-sectional view of a comparative example of the present invention.

### DETAILED DESCRIPTION OF THE INVENTION

The present invention provides a printed oxygen-barrier packaging film substantially free of organic solvent.

As used herein, the phrase “substantially free of organic solvent” means a film having a total retained solvent value of less than 7500 mg/ream as measured in accordance with ASTM F1884-04.

In a specific embodiment, the printed packaging film of the present invention may have a total retained solvent value of between 7500 mg/ream to 5000 mg/ream. In another specific embodiment, the printed packaging film of the present invention may have a total retained solvent value of less than 5000 mg/ream.

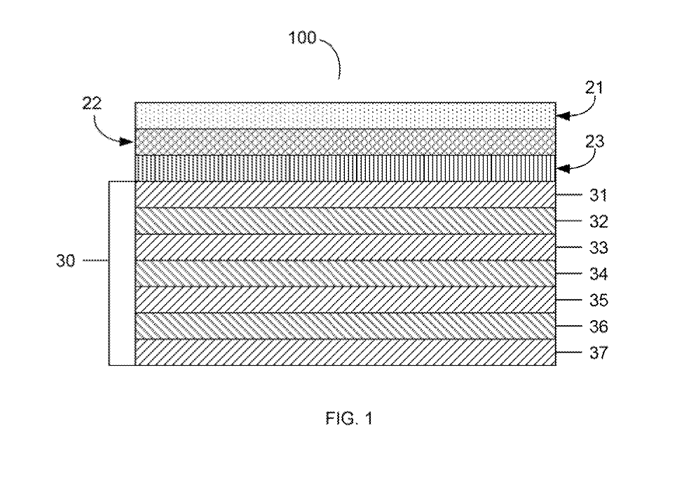

Referring to FIG. 1, shown is a cross-section view of one embodiment of the material of the present invention. As depicted in FIG. 1, printed packaging film 100 comprises a 7-layer multilayer oxygen barrier substrate 30 having an exterior surface of nylon 31, a primer coating on the nylon exterior surface 23, a polyvinylidene chloride coating 22 overlying the primer coating 23, and a printed image 21 covering at least a portion of the polyvinylidene chloride coating 22. Substrate 30 further includes a first tie layer 32, a first interior nylon layer 33, an oxygen barrier layer 34, a second interior nylon layer 35, a second tie layer 36, and a second exterior layer 37. Any known technique may be used to form substrate 30 from the compounded material, including blowing, casting, flat die extruding, etc. In one particular embodiment, the substrate 30 may be formed by a blown process in which a gas (e.g., air) is used to expand a bubble of the extruded polymer blend through an annular die. The bubble is then collapsed and collected in flat film form. Processes for producing blown films are described, for instance, in U.S. Pat. No. 3,354,506 to Raley; U.S. Pat. No. 3,650,649 to Schippers; and U.S. Pat. No. 3,801,429 to Schrenk et al., as well as U.S. Patent Application Publication Nos. 2005/0245162 to McCormack, et al. and 2003/0068951 to Boggs, et al., all of which are incorporated herein in their entirety by reference thereto for all purposes. In yet another embodiment, however, substrate 30 is formed using a casting technique.

Once substrate 30 is formed, an aqueous solution of polyurethane based primer 23 is coated onto the nylon exterior surface layer 31. Any number of methods well known in the art may be used to coat layer 31 with primer 23 including, but not limited to, flexographic or rotogravure printing methods. Preferably, primer coat 23 is applied to layer 31 by gravure printing methods. The polyurethane based primer 23 is applied in a thickness from about 0.2 to about 0.5 lbs./ream, and preferably from about 0.3 to 0.4 lbs./ream. After excess water from the primer coat has been removed by passing substrate 30 through a drying oven, a liquid coating of polyvinylidene chloride 22 is then deposited onto the dried primer coating 23 using conventional flexographic or rotogravure printing methods. Excess water from the polyvinylidene chloride coating 22 is removed passing substrate 30 through a drying oven. Substrate 30 is then placed on a printing press where graphics is applied to the surface of the polyvinylidene chloride coating layer 22. Any known printing technique can be used to print a graphics layer 21 including gravure printing, ink jet printing, silk screen printing, flexographic printing, lithographic printing, electrophotographic printing, intaglio printing, tampo printing, pad printing, letter press printing, etc., preferably gravure or flexographic printing, and more preferably, flexographic printing methods. Any solvent-based printing ink that that has previously been used for printing graphics on flexible food packaging films can be used for forming the printed graphics such as images and/or indicia of the inventive food packaging film. A particular advantage of this invention is that amount of ink and/or number of ink layers need not be limited since polyvinylidene chloride 22 acts as a barrier to ink solvents. As a result, multiple layers of ink can be used to improve the visual depth and spatial effects of the printed graphics. After each layer of ink is applied, it is dried before the next layer of ink is applied. After the final layer of ink is applied and dried, an overprint varnish may be applied to the exterior surface of printed graphics layer 21 if desired.

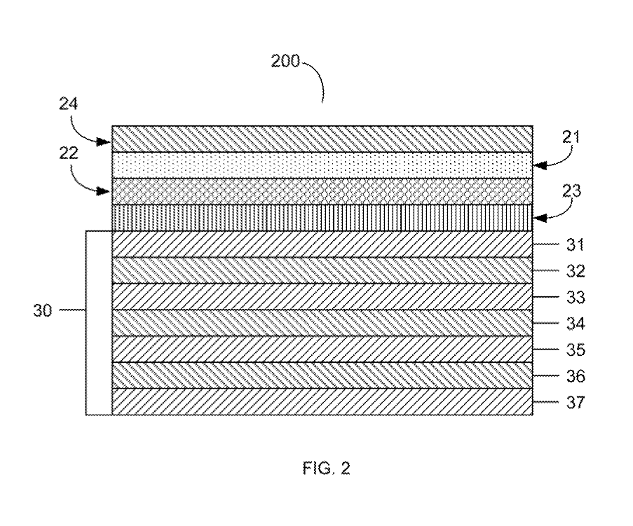

FIG. 2 is a cross-section view of another embodiment of the material of the present invention. As shown, printed packaging film 200 includes a 7-layer multilayer oxygen barrier substrate 30 having an exterior surface of nylon 31, a primer coating on the nylon exterior surface 23, a polyvinylidene chloride coating 22 overlying the primer coating 23, a printed image 21 covering at least a portion of the polyvinylidene chloride coating 22, and an over lacquer 24 covering the printed graphics layer 21. Film 200 is produced in a manner as described above for film 100, except that an overprint varnish 24 is applied onto the exterior surface of printed graphics layer 21.

Overcoat or overprint varnish 24 may be applied to the printed side of the substrate 30, preferably covering the printed graphics layer 21 of the substrate. The overprint varnish 24 may enhance the print or perform a desired result, such as increasing the resistance performance of the print, as is known in the art. Preferably, the overprint varnish is transparent. The overprint varnish is applied in a thickness effective to provide the desired scratch resistance (during film handling and processing) and/or chemical resistance (e.g., to fatty acids, oils, processing aids). However, the overprint varnish thickness should be thin enough not to restrict the film substrate from shrinking or flexing with the film substrate as required by the desired application. Useful overprint varnish thicknesses include from about 0.004 to 0.50 mils (about 0.1 to about 12 μm) preferably from about 0.02 to 0.40 mils (0.5 to about 10 μm), more preferably from about 0.04 to 0.32 mils (1.0 to about 8 μm), and most preferably from about 0.06 to 0.20 mils (1.5 to about 5 μm).

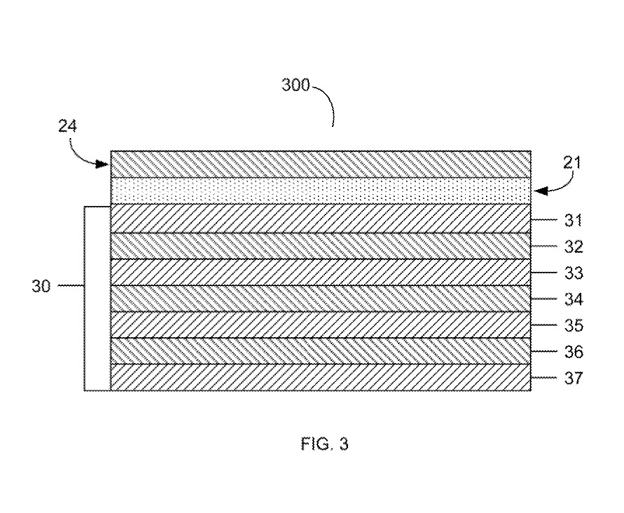

FIG. 3 is a cross-section of a comparative example of the present invention. As depicted, film 300 includes a 7-layer multilayer substrate 30, printed image 21 and an over lacquer covering the printed graphics layer 21. Film 300 is produced in a manner as described above for film 200, except that primer coating 23 and polyvinylidene chloride coating 22 have been omitted.

The total thickness of a representative, multilayer substrate used in a printed packaging film of the present invention, as described herein, is generally from about 24.5 μm (1 mil) to about 380 μm (15 mils), typically from about 51 μm (2 mils) to about 150 μm (6 mils), most typically from about 61.3 μm (2.5 mils) to about 98 μm (4 mils).

In accordance with the present invention, the multilayer substrate can be any polymeric substrate with an exterior surface of nylon which has an oxygen transmission rate of less than 0.015 cm³/mil/100 in²/24 h at 73° F. and 0% RH (or 0.25 cm³/mil/m²/24 h at 23° C. and 0% RH). In another embodiment, the substrate may have an oxygen transmission rate of less than 0.008 cm³/mil/100 in²/24 h at 73° F. and 0% RH (or 0.13 cm³/mil/m²/24 h at 23° C. and 0% RH).

The above description and the following examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

### EXAMPLES

Specifically, the film had the following structures, from the outer to the inner (sealing or food contact) layer:

### Example 1

Example 1 is one embodiment of a packaging film of the present invention having a structure and layer compositions as described below and as illustrated in FIG. 1.
Layer 1 (outer) Multi-layered printed image
Layer 2: 99.50 wt.-% polyvinylidene chloride latex coating (PVdC)—Serfene™ 190 (Rohm and Haas, Philadelphia, Pa., USA)+0.50 wt.-% ceramic microspheres—Zeeospheres 200 (Zeeospheres Ceramics, LLC, Lockport, La., USA)
Layer 3: 100.00 wt.-% urethane based primer coating with isocyanates functionalized co-reactant—Hydroflex WD 4009 (H.B. Fuller Company, St. Paul, Minn., USA)
Layer 4: 77.00 wt.-% nylon 66 DuPont™ Zyter® 42A NC010 (E. I. du Pont de Nemours and Company, Wilmington, Del., USA)+14.00 wt.-% nylon 6—Ultramid® B36 01 (BASF Polyamides and Intermediates, Freeport, Tex., USA)+13.00 wt.-% additives
Layer 5 (1^{st} tie): 93.60 wt.-% linear low density polyethylene (LLDPE)—Dowlex™ 2645G Dow Chemical Company, Midland, Mich., USA)+6.40 wt.-% anhydride modified polyethylene—Tymax™ GT4300 3135X (Westlake Chemical, Houston, Tex., USA)
Layer 6: 100 wt-% nylon 6—Ultramid® B36 01 (BASF Polyamides and Intermediates, Freeport, Tex., USA)
Layer 7: 100 wt.-% ethylene vinyl alcohol copolymer (EVOH)—Soarnol® DT2904R (Soarus LLC, Arlington Heights, Ill. USA)
Layer 8: 100 wt.-% nylon 6—Ultramid® B36 01 (BASF Polyamides and Intermediates, Freeport, Tex., USA)
Layer 9 (2^{nd} tie): 93.60 wt.-% linear low density polyethylene (LLDPE)—Dowlex™ 2645G Dow Chemical Company, Midland, Mich., USA)+6.40 wt.-% anhydride modified polyethylene—Tymax™ GT4300 3135X (Westlake Chemical, Houston, Tex., USA)
Layer 10 (sealing): 87.20 wt.-% ultra-low density polyethylene (ULDPE) Attane NG 4701G (Dow Chemical Company, Midland, Mich., USA)+10.00 wt-% linear low density polyethylene (LLDPE)—ExxonMobil™ 1001.32 (ExxonMobil Chemical, Houston, Tex., USA)+2.80 wt.-% additives.

### Example 2

Example 2 is another embodiment of a packaging film of the present invention prepared with a structure and layer compositions as described below and as illustrated in FIG. 2.
Layer 1 (outer): 100 wt. overprint varnish—2-component lacquer (isocyanates harder and modified polyvinyl chloride binder)-Siegwerk EKD (Siegwerk Druckfarben AG & Co.KGaA, Siegburg, Germany)
Layer 2: Multi-layered printed image
Layer 3: 99.50 wt.-% polyvinylidene chloride latex coating (PVdC)—Serfene™ 190 (Rohm and Haas, Philadelphia, Pa., USA)+0.50 wt.-% ceramic microspheres—Zeeospheres 200 (Zeeospheres Ceramics, LLC, Lockport, La., USA)
Layer 4: 100.00 wt.-% urethane based primer coating with isocyanates functionalized co-reactant—Hydroflex WD 4009 (H.B. Fuller Company, St. Paul, Minn., USA)
Layer 5: 77.00 wt.-% nylon 66—DuPont™ Zytel® 42A NC010 (E. I. du Pont de Nemours and Company, Wilmington, Del., USA)+14.00 wt.-% nylon 6—Ultramid® B36 01 (BASF Polyamides and Intermediates, Freeport, Tex., USA)+13.00 wt.-% additives
Layer 6 (1^{st} tie): 93.60 wt.-% linear low density polyethylene (LLDPE)—Dowlex™ 2645G Dow Chemical Company, Midland, Mich., USA)+6.40 wt.-% anhydride modified polyethylene—Tymax™ GT4300 3135X (Westlake Chemical, Houston, Tex., USA)
Layer 7: 100 wt.-% nylon 6—Ultramid® B36 01 (BASF Polyamides and Intermediates, Freeport, Tex., USA)
Layer 8: 100 wt.-% ethylene vinyl alcohol copolymer (EVOH)—Soarnol®DT2904R (Soarus LLC, Arlington Heights, Ill. USA)
Layer 9: 100 wt.-% nylon 6—Ultramid® 636 01 (BASF Polyamides and Intermediates, Freeport, Tex., USA)
Layer 10 (2^{nd} tie): 93.60 wt.-% linear low density polyethylene (LLDPE)—Dowlex™ 2645G Dow Chemical Company, Midland, Mich., USA)+6.40 wt.-% anhydride modified polyethylene—Tymax™ GT4300 3135X (Westlake Chemical, Houston, Tex., USA)
Layer 11 (sealing): 87.20 wt.-% a ultra-low density polyethylene (ULDPE)—Attane NG 4701G (Dow Chemical Company, Midland, Mich., USA)+10.00 wt-% linear low density polyethylene (LLDPE)—ExxonMobil™ 1001.32 (ExxonMobil Chemical, Houston, Tex., USA)+2.80 wt.-% additives

Example 2 had a thickness of between 74 μm (3.0 mils) to 78 μm (32 mils).

### Example 3

Example 3 is still another embodiment of a packaging film of the present invention prepared with an identical structure as described above for Example 2 and illustrated in FIG. 2, except the thickness varied between 93 μm (3.8 mils) to 98 μm (4.0 mils).

### Comparative Example

Comparative Example was prepared having a structure and layer compositions as described below and as illustrated in FIG. 3.
Layer 1 (outer): 100 wt.-% a overprint varnish—2-component lacquer (isocyanates harder and modified polyvinyl chloride binder)-Siegwerk EKD (Siegwerk Druckfarben AG & Co.KGaA, Siegburg, Germany)
Layer 2 (outer): Multi-layered printed image
Layer 2: 77.00 wt.-% nylon 66—DuPont™ Zytel® 42A NC010 (E. I. du Pont de Nemours and Company, Wilmington, Del., USA)+14.00 wt.-% nylon 6—Ultramid® B36 01 (BASF Polyamides and Intermediates, Freeport, Tex., USA)+13.00 wt.-% additives
Layer 3: 93.60 wt.-% linear low density polyethylene (LLDPE)—Dowlex™ 2645G Dow Chemical Company, Midland, Mich., USA)+6.40 wt.-% anhydride modified polyethylene—Tymax™ GT4300 3135X (Westlake Chemical, Houston, Tex., USA)
Layer 4: 100 wt.-% nylon 6—Ultramid® B36 01 (BASF Polyamides and Intermediates, Freeport, Tex., USA)
Layer 5: 100 wt.-% ethylene vinyl alcohol copolymer (EVOH)—Soarnol® DT2904R (Soarus LLC, Arlington Heights, Ill. USA)
Layer 6: 100 wt.-% nylon 6—Ultramid® B36 01 (BASF Polyamides and Intermediates, Freeport, Tex., USA)
Layer 7: 93.60 wt.-% linear low density polyethylene (LLDPE)—Dowlex™ 2645G Dow Chemical Company, Midland, Mich., USA)+6.40 wt.-% anhydride modified polyethylene—Tymax™ GT4300 3135X (Westlake Chemical, Houston, Tex., USA)
Layer 8: 87.20 wt.-% ultra-low density polyethylene (ULDPE)—Attane NG 4701G (Dow Chemical Company, Midland, Mich., USA)+10.00 wt.-% linear low density polyethylene (LLDPE)—ExxonMobil™ 1001.32 (ExxonMobil Chemical, Houston, Tex., USA)+2.80 wt.-% additives.

Comparative Example had a thickness of between 83 μm (3.4 mils) to 88 μm (3.6 mils).

Oxygen Transmission Rate:

Oxygen transmission rate of films of Example 2, Example 3 and Comparative Example were measured according to ASTM D-3985 test method at 73° F. (23° C.) and 0% Relative Humidity (RH). The results are shown in Table 1. Oxygen transmission rate of films of Example 2, Example 3 and Comparative Example were measured according to ASTM D-3985 test method at 73° F. (23° C.) and 85% Relative Humidity (RH). The results are shown in Table 2. All oxygen transmission rates are expressed per thickness (mils) of each sample.

Water Vapor Transmission Rate:

Water vapor transmission rate of the film of Example 2, Example 3 and Comparative Example were measured according to ASTM D-F-1249 test method at 100° F. (38° C.) and 90% Relative Humidity (RH). Results are shown in Table 3. All water vapor transmission rates are expressed per thickness (mils) of each sample.

Residual Solvents:

The residual solvents released from the films of Example 2, Example 3 and Comparative Example were measured in according to ASTM F-1884 test method. Results are shown in Table 4.

TABLE 1
Oxygen Transmission Rate at 73° F. (23° C.) and
0% Relative Humidity (RH).

| | Thickness | | (cm³/mil/100 in²/24 h) | (cm³/mil/m²/24 h) |
|---|---|---|---|---|
| Example 2 | 74 | μm | 0.014 | 0.22 |
| | (3.0 | mils) | | |
| | 74 | μm | 0.013 | 0.20 |
| | (3.0 | mils) | | |
| Example 3 | 98 | μm | 0.007 | 0.11 |
| | (4.0 | mils) | | |
| | 93 | μm | 0.007 | 0.12 |
| | (3.8 | mils) | | |
| Comparative | 83 | μm | 0.016 | 0.24 |
| Example | (3.4 | mils) | | |
| | 86 | μm | 0.016 | 0.25 |
| | (3.5 | mils) | | |

TABLE 2
Oxygen Transmission Rate at 73° F. (23° C.) and
85% Relative Humidity (RH).

| | Thickness | | (cm³/mil/100 in²/24 h) | (cm³/mil/m²/24 h) |
|---|---|---|---|---|
| Example 2 | 78 | μm | 0.24 | 3.80 |
| | (3.2 | mils) | | |
| Example 3 | 96 | μm | 0.088 | 1.37 |
| | (3.9 | mils) | | |
| | 96 | μm | 0.096 | 1.48 |
| | (3.9 | mils) | | |
| Comparative | 88 | μm | 0.023 | 3.63 |
| Example | (3.6 | mils) | | |
| | 88 | μm | 0.024 | 3.78 |
| | (3.6 | mils) | | |

TABLE 3
Water Vapor Transmission Rate at 100° F. (38° C.) and
90% Relative Humidity (RH).

| | Thickness | | (g/mil/100 in²/24 h) | (g/mil/m²/24 h) |
|---|---|---|---|---|
| Example 2 | 74 | μm | 0.092 | 1.42 |
| | (3.0 | mils) | | |
| | 74 | μm | 0.090 | 1.39 |
| | (3.0 | mils) | | |
| Example 3 | 93 | μm | 0.046 | 0.72 |
| | (3.8 | mils) | | |
| | 91 | μm | 0.041 | 0.64 |
| | (3.7 | mils) | | |
| Comparative | 83 | μm | 0.077 | 1.19 |
| Example | (3.4 | mils) | | |
| | 83 | μm | 0.080 | 1.24 |
| | (3.4 | mils) | | |

TABLE 4
Retained Solvent (mg/ream)

| | | | Comparative |
|---|---|---|---|
| Solvent | Example 2 | Example 3 | Example |
| Methanol | 126 | 314 | 386 |
| Ethanol | 63 | 82 | 216 |
| Isopropanol | 0 | 0 | 151 |
| N-propanol | 1085 | 939 | 5529 |
| Methyl ethyl | 0 | 0 | 0 |
| ketone (MEK) | | | |
| Ethyl acetate | 22 | 35 | 1294 |
| Isopropyl acetate | 0 | 0 | 0 |
| Propyl glycol | 0 | 0 | 0 |
| methyl ether (PM) | | | |
| N-heptane | 0 | 0 | 0 |
| N-propyl acetate | 848 | 499 | 4147 |
| Methyl isobutyl | 73 | 595 | 763 |
| ketone (MIBK) | | | |
| Toluene | 115 | 0 | 632 |
| Isobutyl acetate | 0 | 0 | 103 |
| N-butyl acetate | 167 | 161 | 1196 |
| Propylene glycol | 783 | 385 | 2367 |
| n-propyl ether | | | |
| (PnP) | | | |
| Propyl glycol n- | 942 | 619 | 2100 |
| butyl ether (PnB) | | | |
| Dipropylene glycol | 0 | 0 | 0 |
| methyl ether | | | |
| (DPM) | | | |
| TOTAL | 4224 | 3629 | 18883 |
| SOLVENTS | | | |

What is claimed:

1. A printed packaging film substantially free of organic solvent, comprising:
a multilayer oxygen-barrier substrate having an exterior surface of nylon;
wherein said substrate has an oxygen transmission rate of less than 0.016 cm³/mil/100 in²/24 h at 73° F. and 0% RH (or 0.24 cm³/mil/m²/24 h at 23° C. and 0% RH).
a primer coating on said nylon exterior surface layer of said substrate;
a polyvinylidene chloride coating overlying said primer coating;
a printed graphics layer covering at least a portion of said polyvinylidene chloride coating.

2. The film of claim 1, wherein said substrate further comprises an oxygen-barrier layer of ethylene vinyl alcohol copolymer, nylon or blends thereof.

3. The film of claim 1, wherein the substrate has an oxygen transmission rate of less than 0.008 cm³/mil/100 in²/24 h at 73° F. and 0% RH (or 0.13 cm³/mil/m²/24 h at 23° C. and 0% RH).

4. The film of claim 1, wherein said film has a total retained solvent value of less than 7500 mg/ream.

5. The film of claim 4, wherein said film has a total retained solvent value of between 7500 mg/ream to 5000 mg/ream.

6. The film of claim 4, wherein said film has a total retained solvent value of less than 5000 mg/ream.

7. The film of claim 1, wherein said nylon exterior surface layer is nylon 6.

8. The film of claim 1, wherein said oxygen-barrier layer is ethylene vinyl alcohol copolymer.

9. The film of claim 8, wherein said substrate further comprises a first interior nylon layer and a second interior nylon layer positioned on either side of said oxygen-barrier layer.

10. The film of claim 9, wherein said substrate further comprises a first tie layer positioned between said first exterior surface layer and said first interior nylon layer, and a second tie layer positioned between said second exterior surface layer and said second interior nylon layer.

11. The film of claim 10, wherein said first and second tie layers each comprise a maleic anhydride modified low density polyethylene.

12. The film of claim 1, wherein said substrate further comprises a second exterior surface layer of a heat sealable material.

13. The film of claim 1, wherein said primer coating is an aqueous-based polyurethane dispersion.

14. The film of claim 1, further comprising an over lacquer covering said printed image.

15. The film of claim 1, wherein said polyvinylidene chloride coating is present in an amount of between 2 lb./ream to 4 lb./ream.

16. The film of claim 15, wherein said polyvinylidene chloride coating is present in an amount of between 2.5 lb./ream to 3.5 lb./ream.

17. The film of 1, wherein said primer coating is present in an amount of between 0.2 lb./ream to 0.5 lb./ream.

18. The film of claim 17, wherein said primer coating is present in an amount of between 0.3 lb./ream to 0.4 lb./ream.

19. The film of claim 1, wherein said film has a water vapor transmission rate of less than 0.30 g/100 in²/24 h at 100° F. and 90% RH (or 5.00 cm³/m²/24 h at 23° C. and 0% RH).

20. The film of claim 1, wherein said film has a water vapor transmission rate of less than 0.20 g/100 in²/24 h at 100° F. and 90% RH (or 3.00 cm³/m²/24 h at 23° C. and 0% RH).
